(19) United States
(12) Patent Application Publication
(10) Pub. No.: US 2024/0284251 A1
(43) Pub. Date: Aug. 22, 2024

(54) MITIGATION OF HIGHLY UTILIZED CELL IN WIRELESS NETWORK

(71) Applicant: Rakuten Symphony India Private Limited, Indore, MP (IN)

(72) Inventor: Prithvi Raj DHAKA, Indore (IN)

(73) Assignee: Rakuten Symphony India Private Limited, Indore, MP (IN)

(21) Appl. No.: 18/041,563

(22) PCT Filed: Dec. 28, 2022
(86) PCT No.: PCT/US2022/054113

§ 371 Date: Feb. 14, 2023

(30) Foreign Application Priority Data
Nov. 15, 2022 (IN) 202221065432

(51) Int. Cl. H04W 28/02

(52) U.S. Cl. CPC H04W 28/0289

(57) ABSTRACT

In an embodiment, mitigation of the HUC in the wireless network receives parameters associated with each cell to determine the HUC based on the plurality of parameters associated with cells. A sector class of the HUC is detected and mitigation plan based on the sector class of the HUC is detected. A HUC decongestion report is generated for mitigation of the HUC in the wireless network. The HUC decongestion report includes information about the wireless network, information about the at least one HUC, the sector class of the at last one HUC, and the mitigation plan. The mitigation of the HUC in the wireless network simplifies the process as the apparatus automatically determine and recommend all the possible solution in terms of Macro, Small cell or other solution if any. Therefore, the process provides faster results, improves performance and reduces cost.

### FIELD OF INVENTION

The embodiments disclosed herein generally relates to communication network including large number of base stations, and more particularly, to a method and an apparatus for mitigation of Highly Utilized Cell (HUC) in a wireless network.

### BACKGROUND OF THE INVENTION

In general, 5^{th} Generation (5G) wireless systems represent a next major phase of mobile telecommunication standards beyond current telecommunication standards of 4^{th} Generation (4G). In addition to faster peak internet connection speeds, 5G planning aims at higher capacity than the current telecommunication standards of 4G, allowing a higher number of mobile broadband users per area unit, and allowing consumption of higher or unlimited data quantities. Generally 5G wireless systems also reduce congestion at network node devices (e.g., base stations). Every time User Equipment (UE) device establishes a connection to the network node device, the UE device consumes resources. The resources are limited and can be exhausted if a large number of the UE devices are connected to the network node device, thereby causing the congestion or overloading the network node device. Also, a network topology generally include elements for backhaul network that are used to move traffic “end-to-end” between cellular radio of Radio Access Network (RAN) and a core network or Internet. In some cases, operating conditions of the RAN and the backhaul elements can result in uneven utilization of network resources and can adversely affect user experience. Accordingly, there is a need to jointly manage the radio access network and the backhaul network to optimize end-to-end utilization of network resources.

A load balancing in downlink Long Time Evolution (LTE) Self-Optimizing Network (SON) includes adjusting parameters to obtain high level of network operational performance. In the LTE, concept of the SON is introduced, where the parameter tuning is done automatically based on measurements. The load balancing aims at finding optimum Handover Offset (HO) value between an overloaded cell and a possible target cell. The optimized offset value ensures that the users that are handed over to the target cell, will not be returned to source cell, thus the load in current cell is diminished. Therefore, a solution is required for automatically calculating the load in the cell and recommend all possible solution in terms of macro, small cell and to ensure highest level of accuracy.

Thus, it is desired to address the above mentioned disadvantages or other shortcomings or at least provide a useful alternative.

### OBJECT OF INVENTION

A principal objective of the invention is to provide a method and apparatus for mitigation of a Highly Utilized Cell (HUC) in a wireless network by automatically calculating the HUC by determining plurality of parameters from cells and detecting sector class. Automatically determining or calculating the HUC reduces manual work, which provides faster results, simplifies the process.

Another objective of the invention is to recommend all possible solution for mitigation of the cells in terms of macro, small cell and the like. All possible solutions are recommended automatically in terms of Macro, small cell or other possible solutions, which provides faster results, simplifies the process, improves performance and reduces cost.

### SUMMARY

Embodiments disclosed herein provides an apparatus for mitigation of a Highly Utilized Cell (HUC) in a wireless network. The apparatus receives a plurality of parameters associated with each cell to determine the HUC based on the plurality of parameters associated with cells. A sector class of the HUC is detected and mitigation plan based on the sector class of the HUC is detected. A HUC decongestion report is generated for mitigation of the HUC in the wireless network. The HUC decongestion report includes information about the wireless network, information about the at least one HUC, the sector class of the at last one HUC, and the mitigation plan.

In an embodiment, a method for mitigation of the HUC in the wireless network. The Parameters associated with each cell are received from the plurality of cells. The HUC are determined based on the parameters associated with each cell from the plurality of cells and a sector class is detected for the HUC to determine a mitigation plan based on the sector class of the HUC. The HUC decongestion report is generated for mitigation of the at least one HUC in the wireless network. The HUC decongestion report comprises information about the at least one wireless network, information about the at least one HUC, the sector class of the at last one HUC, and the mitigation plan.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is an overview of a system for mitigation of a highly utilized cell (HUC) in a wireless network, according to embodiments disclosed herein;

FIG. 2 is an apparatus for mitigation of the HUC in the wireless network, according to the embodiments herein;

FIG. 3 is a flow diagram of a method for mitigation of the HUC in the wireless network, according to the embodiments disclosed herein;

FIG. 4 is a flow diagram for determining HUC and generating report based on the determined HUC, according to the embodiments disclosed herein;

FIG. 5 illustrates a new macro sites, according to the embodiments disclosed herein; and

FIG. 6 illustrates an inter site distance of nearest site in geographic area, according to the embodiments disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Referring now to the drawings, where similar reference characters denote corresponding features consistently throughout the figures, there are shown preferred embodiments.

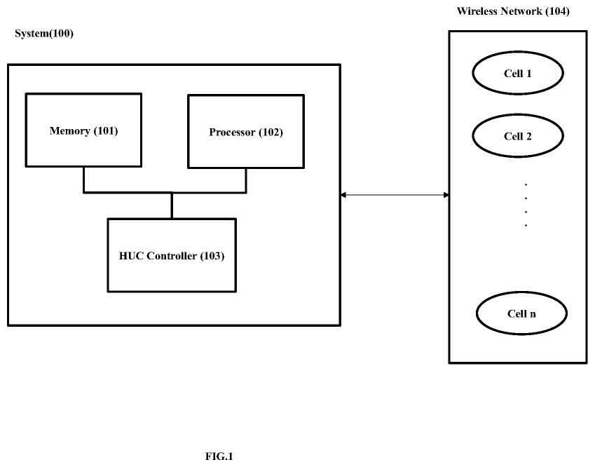

FIG. 1 is an overview of a system (100) for mitigation of a highly utilized cell (HUC) (1-n) in a wireless network (105), according to embodiments disclosed herein.

Although the FIG. 1 shows the hardware elements of the system (100) but it is to be understood that other embodiments are not limited thereon. In other embodiments, the system (100) may include less or more number of elements. Further, the labels or names of the elements are used only for illustrative purpose and does not limit the scope of the invention. One or more components can be combined together to perform same or substantially similar function.

In an embodiment, the system (100) includes a memory (101), HUC controller (103), a processor (102) and a wireless network (104). The wireless network (104) includes multiple cells (1-n).

The memory (101) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) is configured to store larger amounts of information. In certain examples, a non-transitory storage medium may store data that can, over time, change (e.g., in Random Access Memory (RAM) or cache). The memory (101) stores information related to but not limited to multiple parameters related to the cells (1-n), information related to HUC, class of the HUC and the like.

In an embodiment, the processor (102) may include one or a plurality of processors. The one or the plurality of processors (102) may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The processor (102) may include multiple cores and is configured to execute the instructions stored in the memory (102). The processor (102) is configured to execute instructions stored in the memory (101) and to perform various processes. The processor (102) receives the parameters from the cells to determine the HUC. Also, the processor (102) determines sector class of the HUC and generate reports comprising, but not limited to information about the at least one HUC, the sector class of the at last one HUC, and a mitigation plan.

In an embodiment, a HUC decongestion report is sent to HUC controller (103) and the HUC is mitigated based on the information about the HUC such as information about the sector class of the at last one HUC, and information about the mitigation plan mentioned in the HUC decongestion report. The HUC from is determined based on plurality of parameters. The parameters can be sector class information, mitigation plan information mentioned in the HUC decongestion report.

The HUC controller (103) includes an electronic circuit specific to a standard that enables wired or wireless communication. The HUC controller (103) is configured for communicating internally between internal hardware components and with external devices via one or more networks. The HUC controller (103) is configured to mitigate the HUC based on the information about but not limited to the sector class of the at last one HUC, and information about the mitigation plan mentioned in the HUC decongestion report. The HUC decongestion report is stored in the HUC controller (103).

The cell is a geographical area covered by the frequency emitted by a base station in a cellular network. The elements that transmit this frequency is called a cell site. The cellular networks can be GSM (Global System for Mobile communication), GPRS (General Packet Radio Service), CDMA (Code Division Multiple Access) and 3GSM and the like. The HUC are determined and mitigated based on various parameters. Also, the sector class is determined for the HUC based on the number of HUC per sector in the wireless network.

The examples of wireless network include but not limited to cell phone networks, wireless local area networks (WLANs), wireless sensor networks, satellite communication networks, and terrestrial microwave networks. The most common wireless standards used are but not limited to the IEEE 802.11 Wireless LAN (WLAN) & Mesh. The communication between the cells and the system can be performed using the wireless network.

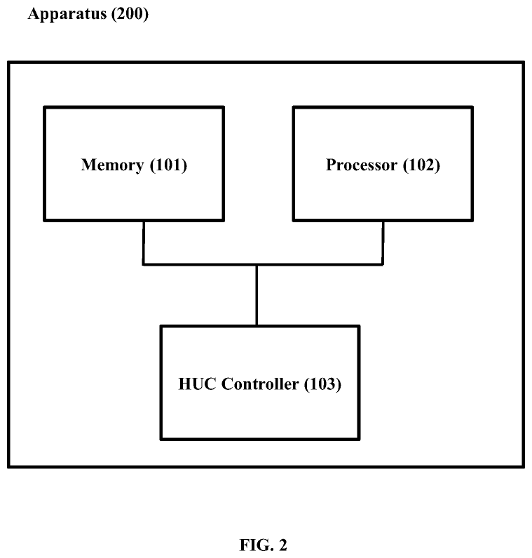

FIG. 2 is the apparatus (200) for mitigation of HUC in the wireless network, according to the embodiments herein. The apparatus (200) includes

In an embodiment, the apparatus (200) includes the memory (101), the HUC controller (103), and the processor (102).

The memory (101) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) is configured to store larger amounts of information. In certain examples, a non-transitory storage medium may store data that can, over time, change (e.g., in Random Access Memory (RAM) or cache). The memory (101) stores information related to but not limited to multiple parameters related to the cells (1-n), information related to HUC, class of the HUC and the like.

In an embodiment, the processor (102) may include one or a plurality of processors. The one or the plurality of processors (102) may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The processor (102) may include multiple cores and is configured to execute the instructions stored in the memory (102). The processor (102) is configured to execute instructions stored in the memory (101) and to perform various processes. The processor (102) receives the parameters from the cells to determine the HUC. Also, the processor (102) determines sector class of the HUC and generate reports comprising, but not limited to information about the at least one HUC, the sector class of the at last one HUC, and the mitigation plan.

In an embodiment, the HUC decongestion report is sent to HUC controller (103) and the HUC is mitigated based on the information about the HUC such as information about the sector class of the at last one HUC, and information about the mitigation plan mentioned in the HUC decongestion report. The HUC from is determined based on the plurality of parameters. The parameters can be sector class information, mitigation plan information mentioned in the HUC decongestion report.

The HUC controller (103) includes an electronic circuit specific to a standard that enables wired or wireless communication. The HUC controller (103) is configured for communicating internally between internal hardware components and with external devices via one or more networks. The HUC controller (103) is configured to mitigate the HUC based on the information about but not limited to the sector class of the at last one HUC, and information about the mitigation plan mentioned in the HUC decongestion report. The HUC decongestion report is stored in the HUC controller (103).

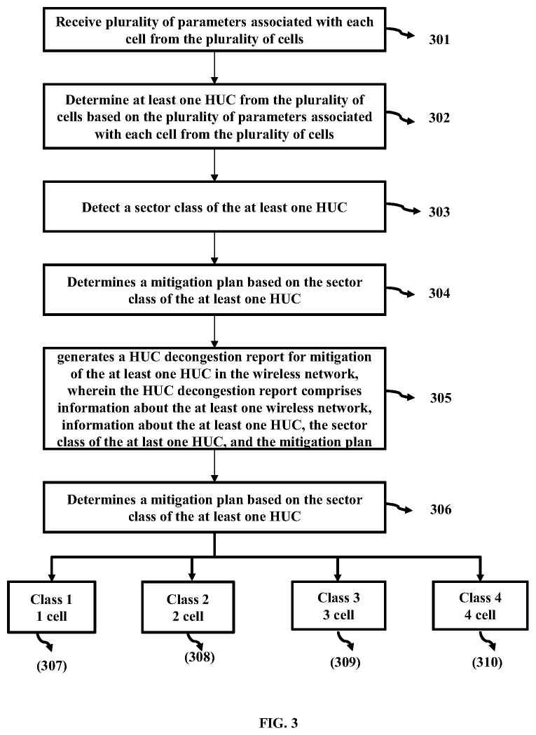

FIG. 3 is the flow diagram of the method for mitigation of the HUC in the wireless network, according to the embodiments disclosed herein.

At step 301, plurality of parameters of the multiple cells are received. The plurality of parameters can be but not limited to HUC criteria, physical resource blocks (PRB) utilization an Internet Protocol (IP) throughput. For instance if the criteria can be average DownLink (DL) PRB utilization percentage greater than nearly 70 and if the IP throughput less than 2 Mbps (congested), then the cell is considered as HUC.

At step 302, the one or more HUC cells are determined based on the parameters of the cells. The parameters can be one or multiple. The HUC cell can be one or multiple cells based on the areas of the users of the network.

At step 303, the sector class is detected for the HUC. The sector class are detected by the number of the HUC per sector per site in the wireless network and the sector class of the HUC based on the number of HUC per sector per site in the wireless network. Mitigating the HUC based on the information about the HUC information about the sector class and information about the mitigation plan mentioned in the HUC decongestion report.

At step 304, the mitigation plan based on the sector class is determined for the HUC. The mitigation plan can include but not limited to an additional layer solution, a proposed bi-sector antenna solution, a proposed outdoor small cell solutions, a planned IDSC solution, a new macro site solution, and a planned macro site solution and the like. The sector class can be the determined by detecting the number of HUC per sector per site an detecting the sector class of the HUC based on the number of HUC sector per site in the wireless network.

At step 305, the HUC decongestion report is generated for mitigation of the HUC and the HUC decongestion report comprise information about the wireless network, information about the HUC, the sector class of the HUC and the mitigation plan.

At step 306, the mitigation plan is determined based on the sector class of the HUC. The sector class can be but not limited to class 1, class 2, class 3 and class 4.

At step 307 to step 310, the classes are determined based on per sector per site. The sectors can be divided based on the number of cells. The class 1 includes 1 cell, class 2 includes 2 cell, class 3 includes 3 cell, and class 4 includes 4 cell.

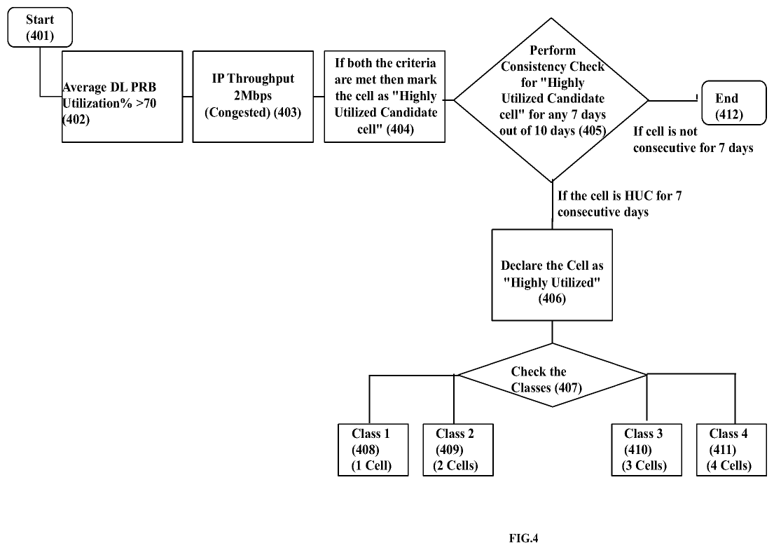

FIG. 4 is the flow diagram for determining HUC and generating report based on the determined HUC, according to the embodiments disclosed herein. The flow chart includes determining the criteria for the HUC and generating the report based on the HUC.

At step 402, the criteria of the HUC is determined. The criteria can be, if the average DL PRB utilization of the cell is greater than 70%, and if the IP throughput of the cell is less than 2 Mbps (Congested), then consistency check for the HUC is performed at step (405). In the downlink, the concept of PRBs is used for specifying the mapping of physical channels and signals onto resource elements.

At step 403, the IP throughput is determined for the multiple cells. The throughput is a measure of how many units of information a system can process in a given amount of time. It is applied broadly to systems ranging from various aspects of computer and network systems to organizations.

At step 404, checked if the criteria of average DL PRB utilization and the IP throughput are met or satisfied. If the criteria of the multiple cell is met, then step 405 is performed to check the consistency of the HUC.

At step 405, consistency of the HUC is determined. If the consistency of the highly utilized candidate cell is for 7 days out of 10 days, then the cell is declared as HUC. Else the step 412 is performed and the cell is marked as the decongestion cell or un-utilized cell.

At step 406, if the consistency check for the highly utilized candidate cell can be for example checked for 7 days out of 10 days. If the cell is meeting the criteria for consecutive 7 days or any 7 days, then the cell is declared as HUC, as disclosed at step (406). Further, if the consistency check of the HUC do not meet the criteria or if the cell is not consistent for 7 consecutive days, then the cell is not considered as the HUC.

At step 407, the classes of the HUC are checked and categorized into multiple classes based on per site per cell.

At step 408 to 411, the classes are determined based on per sector per site. The sectors can be divided based on the number of cells. The classes for example includes 1 cell in first class, second class includes 2 cell, third class includes 3 cell, and fourth class includes 4 cell.

In an embodiment, the report takes the output of the multiple cells from the balanced HUC report and provides the following options for each HUC cells:
Class 1: Per site, per sector if one cell reported in HUC
Class 2: Per site, per sector if two cells reported in HUC
Class 3: Per site, per sector if three cells (carrier1, carrier2, carrier3) reported in HUC

In an embodiment, overshooting parameter is also checked. The overshooting parameter includes over shooter, wanted over shooter, or blank.

In an embodiment, mis-alignment is determined. The mis-alignment disclose, if the sector is mi-aligned or not. The mis-alignment gives the amount of misalignment in terms of number of degrees of mis-alignment. Any sector greater than 20 degree mis-alignment is used to show sectors.

In an embodiment, the following conditions can be used for spectrum augmentation in the additional layer solution in mitigation plan. The additional layer solution includes determining the Frequency Division Duplexing (FDD) layer and a Time-Division Duplexing (TDD) layer is enabled. The generation of the proposed additional layer solution includes information of the FDD layer and TDD layer and also an addition of first layer (c) and second layer (C1) and a third layer (C2).
C=850 MHz (FDD 10 MHz)/C1=2300 MHz (TDD 20 MHz)/C2=2300 MHz (TDD 10 MHz)
In case HUC site is 850 MHz (C) Layer, then propose 2300 MHz 20 MHz (C1) layer
In case HUC Site is 850 MHz (C)+2300 MHz (C1) then propose 2300 MHz (C2)
In case HUC Site is 2300 MHz (C1) only then propose 2300 MHz (C2)
In case HUC site is 2300 MHz (C1) and (C2) then Propose 850 MHz (C)
In case HUC site is 2300 MHz (C2) then propose 2300 MHz (C1)

For this logic to work. Sector Data Base in Foresight has Correct Latitude and Longitude, Azimuth & Band filled for all sectors.

In an embodiment, determining the proposed Bi-Sector Antenna solution includes determining whether all the three layers (C, C1. C2) are optional. Further, the combined PRB utilization (BBH level) is checked for all layers and if the layers are greater than PRB utilization threshold, then the option is given for the bi-sectorization. The criteria can be 55%. In an embodiment, if both FDD and TDD layer of the sector are reported in HUC, then sector addition will be opted for FDD layer only. Further, If the difference between the DL PRB utilization (BBH level) of any two layers is more than the utilization threshold, then the traffic balance is written as “yes” on traffic balancing, else the layer is kept blank or unmarked. The utilization threshold can be for example, but not limited to 40%.

In an embodiment, it is to be noted that in case of 3 layers calculate the difference between max PRB utilization layer and min PRB utilization layer. For example, one sector has 3 layers PRB utilization is as follows; FDD 10 MHz to 75% (Max) or TDD 20 MHz to 45% or TDD 10 MHz to 32% (Min). So the difference between Max PRB utilization and Min PRB utilization as shown in equation (1). Hence the layer is made as “yes” for the load balancing.

$$75 \% - 35 \% is 43 \% . \qquad Equation ( 1 )$$

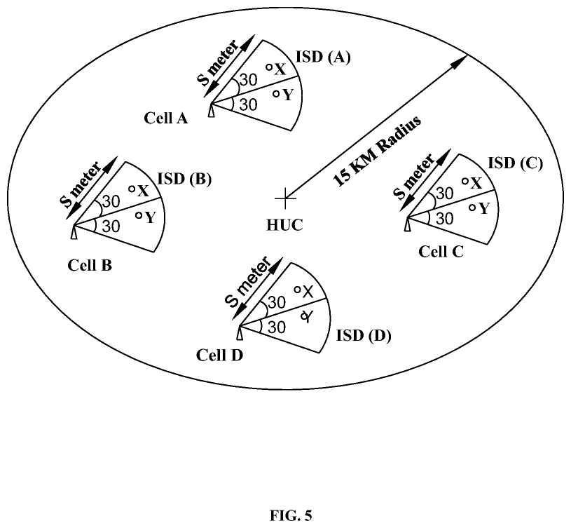

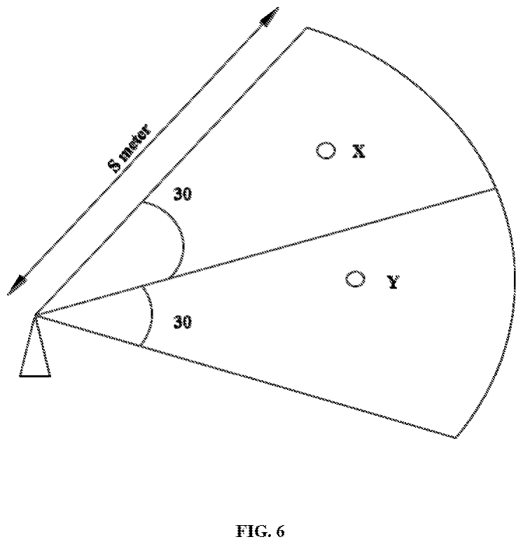

FIG. 5 illustrates the new macro sites, according to the embodiments disclosed herein. In an embodiment, a first Inter-Site Distance (ISD) of the HUC cell to each macro cell available in a predefined radius. In an embodiment, the first ISD of the area is around the HUC cell is found out of the radius is of S meters. The default value of S can be taken as 15 KM. The ISD is calculated for each cell within 15 KM around the HUC. The proposed macro site solution is generated by combining the ISD from the HUC to each macro cell available in the predefined radius. The proposed macro site solution includes a nominal identifier for the proposed new macro site cell, latitude of the proposed new macro cell, longitude of the proposed new macro cell, and a tower provider collocated information when the proposed new macro cell is co-located with any collocated tower provider site. For example, as shown in FIG. 5, 4 cells in the radius of 15 KM around HUC. The ISD of each cell is calculated with respect to sites in a cone. Post calculation of ISD per cell in the circle of 15 KM, averaging is done to calculate the Average ISD”. In an embodiment, only MACRO cells are considered for Average ISD calculations as shown in equation (2). The Radius of cone to calculate the ISD can be kept as 6 Km and the inter site distance calculation per cell using a cone is described in FIG. 6.

$$Avg ISD = ( ISD ( A ) + ISD ( B ) + ISD ( C ) + ISD ( D ) ) / 4$$

FIG. 6 illustrates inter site distance of nearest site in geographic area, according to the embodiments disclosed herein. An Azimuth, latitude, longitude of source cell are considered. The ISD is determined from the at least one HUC cell to each macro cell available in a predefined radius. The proposed macro site solution is generated by combining the ISD from the at least one HUC cell to each macro cell available in the predefined radius. The proposed macro site solution includes a nominal identifier for a proposed new macro cell, latitude of the proposed new macro cell, longitude of the proposed new macro cell, and a tower provider collocated information whene the proposed new macro cell is co-located with any collocated tower provider site. Further, predefined radius is determined to calculate the ISD. For example, the ISD can be 6 Km. From the center Azimuth of the cell, an arc is created at positive 30 or negative 30 at distance ‘S’ meter. A planned or On-air Macro and ODSC sites are checked whether the sites are present inside the polygon. Considering, two sites inside the polygon X and Y then, D1 refers to a distance of X site from cell, D2 is a distance of Y site from the cell and D′n′; is a distance of n site from cell if any as shown below in equation (3):

$$ISD = ( D 1 + D2 + …… ) / Number of sites \qquad Equation ( 3 )$$

Further, checked if the ISD of the nearest site in a main lobe (cone around the sector with azimuth of 120 degrees) of the cell is less than the 1.5 times the average inter site distance. If yes, then no macro site is required. If No, a new infill macro site is given as an option, with nominal as the half of the distance between the HUC cell and the nearest neighbor. Before confirming this new nominal, it is further checked if there is any existing/planned macro/ODSC within 0.75×Average ISD from the newly found nominal. If yes again the new infill site is not given as an option. If No, then the new macro is needed, and Latitude/longitude is fine-tuned with tower mapping. If there is any Tower around 50 meters of this new nominal, then the Latitude/longitude of the TP is provided as the nominal of the new macro site instead of the nominal located earlier.

In an embodiment, the planned macro site solution is determined by checking whether any existing planned macro site is available in a serving area of a site in the wireless network. A roll out status of the planned macro site is retrieved from a site master database when the planned macro site is available in a serving area of a site in the wireless network. Further, an Element Management System (EMS) live status of the planned macro site is retrieved from the site master database for generating the planned macro site solution comprising a name of the planned macro site, latitude of the existing planned macro site, longitude the planned macro site, the roll out status of the planned macro site, and the EMS live status of the planned macro site.

The roll out status of the planned macro can be taken from the site master database. As soon as a new macro is planned in Site forge, the new macro will be reflected in Foresight. Live_EMS field will also be populated from the Master DB, as sometimes the site is not formally declared on-Air, but it has been switched on and has already started to take traffic. Serving area of the HUC Site: The serving area can also be identified in the cone around the sector with azimuth of 120 degrees around the azimuth with radius of (average inter site distance×1.5). The serving area of the site is used for ODSC and IDSC options.

In an embodiment, the proposed ODSC solution is determined. The proposed ODSC solution is determined by identifying a number of grids available in a predefined distance for at least two proposed ODSC in a serving area of the at least one HUC. The number of grids can be but not limited to 100×100 metres for ODSC in the serving area of the HUC site from the ODSC report. The number of such 100×100 metres can be zero, one or more, but only first two will be included in the report. The proposed ODSC solution is generated including building name or pole identifier, latitude of the building name or pole identifier for the at least two proposed ODSC, and longitude of the building name or pole identifier for the at least two proposed ODSC. For the identified ODSCs, display the information of 1st candidate for that grid. For each such 100×100 mtr grid, the nominal of the ODSC is taken from the Latitude/longitude of the most dominant 20×20 metres child grid.

In an embodiment, the planned ODSC solution is determined. Determining the planned ODSC solution is determined by checking whether any existing planned ODSC is available in a serving area of a site in the wireless network. The roll out status of the at least two planned ODSC are retrieved from a site master database when the two planned ODSC are available in a serving area of the site in the wireless network. As soon as the ODSC is planned in Site forge, ODSC will be reflected in Foresight. Initially till site forge is not rolled out, these fields will be blank. Later it will start to get populated The EMS live status of the at least two planned ODSC are retrieved from the site master database to generate the planned ODSC solution comprising a name of an existing building or pole, latitude of the at least two planned ODSC, longitude of the two planned ODSC, the roll out status of the at least two planned ODSC, and the EMS live status of the at least two planned ODSC. A Live_EMS field will also be populated from the Master DB, as sometimes the site is not formally declared on-Air, but it has been switched on and has already started to take traffic.

In an embodiment, the proposed IDSC solution is determined. Determining the proposed IDSC solution includes determining at least five buildings available in a predefined distance for two proposed ODSC in a serving area of the at least one HUC for generating the proposed IDSC solution comprising buildings name, latitude of the at least five buildings, and longitude of the at least five buildings, and an Area covered for the at least five buildings. In case more than 5 buildings are coming in IDSC report then Top 5 buildings in descending order of % Area covered will be selected. The percentage area covered is greater than 100 dBM samples per building from Smart Network Layer (SNC).

In an embodiment, determining the planned IDSC solution includes checking whether any existing planned IDSC is available in a serving area of a site in the wireless network. The roll out status of the at least three planned IDSC are retrieved from a site master database when the three planned IDSC are available in a serving area of the site in the wireless network and an EMS live status of the three planned IDSC is retrieved from the site master database. The planned IDSC solution is generated including a name of an existing building or pole, latitude of the at least three planned IDSC, longitude of the three planned IDSC, the roll out status of the three planned IDSC, and the EMS live status of the three planned IDSC. As soon as an IDSC is planned in Site forge, IDSC will be reflected in Foresight. Initially till site forge is not rolled out, the fields will be blank. Later it will start to get populated. Levees field will also be populated from the Master DB, as sometimes the site is not formally declared on-Air, but it has been switched on and has already started to take traffic. The information about the wireless network can include a network region, a number of HU sites in the network region, a number of HUC sectors in the network region, and a number of HU cells in the network region. The information about the at least one HUC of the at last one HUC can include a service provider of the at least one HUC, latitude of the at least one HUC, longitude of the at least one HUC, the sector information of the at least one HUC, a cell name of the at least one HUC, bands supported by the at least one HUC. The plurality of parameters can include PRB utilization and an IP throughput.

In an embodiment, an automatic decongestion report is prepared based on 1) network region wise summary 2) city wise summary 3) HUC decongestion report.

The network wise summary includes network region, number of HU sites, number of HU sites, number of HU cells, number of HU sectors, proposed decongestion solutions, planned decongestion solutions as shown in Table 1 including network region wise summary format. Table. 2 discloses city wise summary format. Table. 3 discloses HUC decongestion report.

TABLE 1

| Column Title | | Description |
|---|---|---|
| Network Region | | Geography L1 (Region) |
| No. of HU Sites | | Count of HU Sites per Region |
| No. of HU Sectors | | Count of HU Sectors per Region |
| No. of HU Cells | | Count of HU Cells per Region |
| Proposed | Additional Layer | Count of Additional Layer |
| Decongestion | | proposed per Region |
| Solutions | Bi-Sector Antenna | Count of Bisector Proposed Per Region |
| | IDSC | Count of IDSC Proposed per Region |
| | ODSC | Count of IDSC Proposed per Region |
| | New Macro Site | Count of New Macro Proposed per |
| | | Region |
| Planned | Macro Site | Count of Planned Macro Sites per |
| Decongestion | | Region |
| Solutions | ODSC | Count of Planned ODSC per Region |
| | IDSC | Count of Planned IDSC per Region |

TABLE 2

| Column Title | | Description |
|---|---|---|
| Network Region | | Geography L1 (Region) |
| City | | Geography L2 (City) |
| No. of HU Sites | | Count of HU Sites per city |
| No. of HU Sectors | | Count of HU Sectors per city |
| No. of HU Cells | | Count of HU Cells per city |
| Proposed | Additional Layer | Count of Additional Layer |
| Decongestion | | proposed per city |
| Solutions | Bi-Sector Antenna | Count of Bisector Proposed Per |
| | | city |
| | IDSC | Count of IDSC Proposed per city |
| | ODSC | Count of IDSC Proposed per city |
| | New Macro Site | Count of New Macro Proposed |
| | | per city |
| Planned | Macro Site | Count of Planned Macro Sites per |
| Decongestion | | city |
| Solutions | ODSC | Count of Planned ODSC per city |
| | IDSC | Count of Planned IDSC per city |

TABLE 3

| Column Title | | | Description |
|---|---|---|---|
| Network Region | | | Geography L1 |
| City | | | Geography L2 |
| City 1 | | | Geography L3 |
| City 2 | | | Geography L4 |
| Highly Utilized | | Vendor | Vendor of the HUC |
| Sector Details | | Site Name | Site Name of the Highly Utilized Cell |
| | | | (HUC) |
| | | Latitude | Latitude of the HUC |
| | | Longitude | Longitude of the HUC |
| | | Sector | Sector of site with respect to HU Cell |
| | | | (Sitename_1/2/3) |
| | | Sector Class | Class 1: Per site, per sector if one cell |
| | | | reported in H.U.C |
| | | (High Utilization) | Class 2: Per site, per sector if two cells |
| | | | reported in H.U.C |
| | | | Class 3: Per site, per sector if three cells |
| | | | reported in H.U.C |
| | | Cell Name | Cell Name of the HUC |
| | | | (SiteName_CNUM). |
| | | | CNUM: |
| | | | 11/12/13 . . . 21/22/23 . . . 31/32/33 . . . 1 |
| | | Band | Band of the HUC 2300 TDD(20 MHz)/ |
| | | | 2300 TDD (10 MHz)/850FDD (10 MHz) |
| Cell Coverage | | Overshooter | IS HUC an Over shooter? Wherever non |
| | | | blank it will classify |
| | | | i) Bad Overshooting ii) Wanted |
| | | | Overshooting |
| | | Sector Alignment | If Value is non Blank, then it |
| | | | shows the angle by which Azimuth |
| | | | is misaligned greater |
| | | | than 20Degree |
| Additional Layer | | Band Available | TDD => TDD only |
| | | on Sector | FDD => FDD Only |
| | | (TDD/FDD/ | TDD_FDD => Both TDD and FDD |
| | | TDD-FDD) | |
| | | New layer | Layer proposed as new layer addition. |
| | | Option | 850 MHz FDD/2300 MHz 10 MHz/ |
| | | | 2300 MHz 20 MHz |
| Bi-Sectorization | | Bi-Sectorization | Bisectorization for the Cell (Yes/No). |
| | | Option | Condition 1: All three layers already |
| | | (Yes/No) | present. |
| | | | Condition 2: Combined Aggregated DL |
| | | | PRB Util >55% |
| | | Traffic Balancing | If DL PRB Utilization difference between |
| | | Option | 2 layers |
| | | | of the same sector >40% |
| Proposed | | Nominal Id | Nominal Id for the proposed New Macro |
| New Macro | | Latitude | Latitude of the proposed New Macro |
| | | Longitude | Longitude of the proposed New Macro |
| | | Tower Provider Co- | If New Macro nominal is co-located with |
| | | Lo | any |
| | | (Yes/No) | Collocated Tower Provider site then put |
| | | | “Yes”, otherwise “No” |
| Planned Macro | | Planned Site ID | Name of the site |
| | | Latitude | Latitude of the planned infill site |
| | | Longitude | Longitude of the planned infill site |
| | | Rollout Status | Rollout Status |
| | | EMS_Live Status | EMS Live Status |
| Proposed | ODSC 1 | Building Name/ | Building Name/Pole ID of the |
| New | | Pole | respective Building |
| ODSCs | | Latitude | Latitude of the respective Building |
| | | | Name/Pole ID |
| | | Longitude | Longitude of the respective Building |
| | | | Name/Pole ID |
| | ODSC 2 | Building Name/ | Building Name/Pole ID of the |
| | | Pole | respective Building |
| | | Latitude | Latitude of the respective Building |
| | | | Name/Pole ID |
| | | Longitude | Longitude of the respective Building |
| | | | Name/Pole ID |
| Planned | ODSC 1 | Building Name/ | Name of the Building/Pole |
| ODSCs | | Pole | |
| | | Site Name | Site name of Planned ODSC |
| | | Latitude | Latitude of the Planned ODSC |
| | | Longitude | Longitude of the Planned ODSC |
| | | Rollout Status | Rollout Status |
| | | EMS_Live Status | EMS Live Status |
| | ODSC 2 | Building Name/ | Name of the Building/Pole |
| | | Pole | |
| | | Site Name | Site name of Planned ODSC |
| | | Latitude | Latitude of the Planned ODSC |
| | | Longitude | Longitude of the Planned ODSC |
| | | Rollout Status | Rollout Status |
| | | EMS_Live Status | EMS Live Status |
| Proposed | Building | Building Name | Building Name of the Nth Enterprise building |
| New | 1 | Latitude | Latitude of the Nth Enterprise building |
| IDSC | | Longitude | Longitude of the Nth Enterprise building |
| (5 | | % Area | % Area covered >= −100 dBm of the Nth |
| Buildings) | | covered >= −100 dBm | Enterprise building |
| | Building | Building Name | Building Name of the Nth Enterprise building |
| | 2 | Latitude | Latitude of the Nth Enterprise building |
| | | Longitude | Longitude of the Nth Enterprise building |
| | | % Area | % Area covered >= −100 dBm of the Nth |
| | | covered >= −100 dBm | Enterprise building |
| | Building | Building Name | Building Name of the Nth Enterprise building |
| | 3 | Latitude | Latitude of the Nth Enterprise building |
| | | Longitude | Longitude of the Nth Enterprise building |
| | | % Area | % Area covered >= −100 dBm of the Nth |
| | | covered >= −100 dBm | Enterprise building |
| | Building | Building Name | Building Name of the Nth Enterprise building |
| | 4 | Latitude | Latitude of the Nth Enterprise building |
| | | Longitude | Longitude of the Nth Enterprise building |
| | | % Area | % Area covered >= −100 dBm of the Nth |
| | | covered >= −100 dBm | Enterprise building |
| | Building | Building Name | Building Name of the Nth Enterprise building |
| | 5 | Latitude | Latitude of the Nth Enterprise building |
| | | Longitude | Longitude of the Nth Enterprise building |
| | | % Area | % Area covered >= −100 dBm of the Nth |
| | | covered >= −100 dBm | Enterprise building |
| Planned | IDSC 1 | Building Name | Name of the Building/Pole |
| IDSC | | Site Name | Site name of Planned IDSC |
| | | Latitude | Latitude of the Planned IDSC |
| | | Longitude | Longitude of the Planned IDSC |
| | | Rollout Status | Rollout Status |
| | | EMS_Live Status | EMS Live Status |
| | IDSC 2 | Building Name | Name of the Building/Pole |
| | | Site Name | Site name of Planned IDSC |
| | | Latitude | Latitude of the Planned IDSC |
| | | Longitude | Longitude of the Planned IDSC |
| | | Rollout Status | Rollout Status |
| | | EMS_Live Status | EMS Live Status |
| | IDSC 3 | Building Name | Name of the Building/Pole |
| | | Site Name | Site name of Planned IDSC |
| | | Latitude | Latitude of the Planned IDSC |
| | | Longitude | Longitude of the Planned IDSC |
| | | Rollout Status | Rollout Status |
| | | EMS_Live Status | EMS Live Status |

In an embodiment, mitigation of the HUC in the wireless network receives a plurality of parameters associated with each cell to determine the HUC based on the plurality of parameters associated with cells. A sector class of the HUC is detected and mitigation plan based on the sector class of the HUC is detected. A HUC decongestion report is generated for mitigation of the HUC in the wireless network. The HUC decongestion report includes information about the wireless network, information about the at least one HUC, the sector class of the at last one HUC, and the mitigation plan. The mitigation of the HUC in the wireless network simplifies the process as the apparatus automatically determine and recommend all the possible solution in terms of Macro, Small cell or other solution if any. Therefore, the process provides faster results, improves performance and reduces cost.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. An apparatus (100) for mitigation of a highly utilized cell (HUC) in a wireless network comprising a plurality of cells, wherein the apparatus comprises:
a memory;
a processor communicatively coupled to the memory, and configured to:
receive a plurality of parameters associated with each cell from the plurality of cells;
determine at least one HUC from the plurality of cells based on the plurality of parameters associated with each cell from the plurality of cells;
detect a sector class of the at least one HUC;
determine a mitigation plan based on the sector class of the at least one HUC; and
generate a HUC decongestion report for mitigation of the at least one HUC in the wireless network, wherein the HUC decongestion report comprises information about the at least one wireless network, information about the at least one HUC, the sector class of the at last one HUC, and the mitigation plan.

2. The apparatus as claimed in claim 1, wherein the apparatus is configured to mitigate the at least one HUC based on the information about the at least one HUC, information about the sector class of the at last one HUC, and information about the mitigation plan mentioned in the HUC decongestion report.

3. The apparatus as claimed in claim 1, wherein the apparatus is configured to:
send the HUC decongestion report to the at least one HUC;
receive the HUC decongestion report; and
mitigate the at least one HUC based on the information about the at least one HUC, information about the sector class of the at last one HUC, and information about the mitigation plan mentioned in the HUC decongestion report.

4. The apparatus as claimed in claim 1, determines the at least one HUC from the plurality of cells based on the plurality of parameters associated with each cell from the plurality of cells comprises:
for each cell from the plurality of cells, determine whether the plurality of parameters meets a HUC criteria;
detect at least one candidate cell from the plurality of cells whose parameters meets the HUC criteria;
determine whether the at least one candidate cell consistently meets the HUC criteria for a period of time; and
identify the at least one candidate cell as the at least one HUC when the at least one candidate cell consistently meets the HUC criteria for the period of time.

5. The apparatus as claimed in claim 1, detects the sector class of the at least one HUC to:
detect, by the apparatus, a number of HUC per sector per site in the wireless network; and
detect, by the apparatus, the sector class of the at least one HUC based on the number of HUC per sector per site in the wireless network.

6. The apparatus as claimed in claim 1, wherein the mitigation plan comprises a proposed additional layer solution, a proposed bi-sector antenna solution, a proposed Outdoor Small Cells (ODSC) solution, a planned ODSC solution, a proposed Indoor Small Cell (IDSC) solution, a planned IDSC solution, a new macro site solution, and a planned macro site solution.

7. The apparatus as claimed in claim 6, determine the proposed additional layer solution comprises:
determine at least one a Frequency-division duplexing (FDD) layer and a Time-division duplexing (TDD) layer is enabled; and
generate the proposed additional layer solution comprises
information of at least one of a FDD layer and a TDD layer, and
an addition of one of a first layer (C), a second layer (C1) and a third layer (C3).

8. The apparatus as claimed in claim 6, determine the proposed Bi-Sector Antenna solution comprises:
determines whether all three layers (C, C1, and C3) are operational;
determines whether an aggregated Physical Resource Block (PRB) utilization meets a aggregated PRB utilization threshold;
determines a difference between the PRB utilization of any two layers meets a layer PRB utilization threshold; and
generates the proposed Bi-Sector Antenna solution comprising:
enablement of a bi-sectorization option when all the three layers (C, C1, and C3) are operational, the meets the aggregated Physical Resource Block (PRB) utilization threshold; and
enablement of a traffic balancing option when the difference between the PRB utilization of any of the two layers meets the layer PRB utilization threshold.

9. The apparatus as claimed in claim 6, determines the new macro site solution comprises:
determines an Inter-Site Distance (ISD) from the at least one HUC cell to each macro cell available in a predefined radius; and
generates the proposed macro site solution by combining the ISD from the at least one HUC cell to each macro cell available in the predefined radius, wherein the proposed macro site solution comprises a nominal identifier for a proposed new macro cell, latitude of the proposed new macro cell, longitude of the proposed new macro cell, and a tower provider collocated information when the proposed new macro cell is co-located with any collocated tower provider site.

10. The apparatus as claimed in claim 6, determines the planned macro site solution comprises:
determines whether any existing planned macro site is available in a serving area of a site in the wireless network;
retrieves a roll out status of the planned macro site from a site master database when the planned macro site is available in a serving area of a site in the wireless network;
retrieves an Element Management System (EMS) live status of the planned macro site from the site master database; and
generates the planned macro site solution comprising a name of the planned macro site, latitude of the existing planned macro site, longitude the planned macro site, the roll out status of the planned macro site, and the EMS live status of the planned macro site.

11. The apparatus as claimed in claim 6, determines the proposed ODSC solution to:
identify a number of grids available in a predefined distance for at least two proposed ODSC in a serving area of the at least one HUC; and
generate the proposed ODSC solution comprising building name or pole identifier, latitude of the building name or pole identifier for the at least two proposed ODSC, and longitude of the building name or pole identifier for the at least two proposed ODSC.

12. The apparatus as claimed in claim 6, determines the planned ODSC solution to:
determine whether any existing planned ODSC is available in a serving area of a site in the wireless network;
retrieve a roll out status of the at least two planned ODSC from a site master database when the two planned ODSC are available in a serving area of the site in the wireless network;
retrieve an EMS live status of the at least two planned ODSC from the site master database; and
generates the planned ODSC solution comprising a name of an existing building or pole, latitude of the at least two planned ODSC, longitude of the two planned ODSC, the roll out status of the at least two planned ODSC, and the EMS live status of the at least two planned ODSC.

13. The apparatus as claimed in claim 6, determine the proposed IDSC solution to:
determines at least five buildings available in a predefined distance for two proposed ODSC in a serving area of the at least one HUC; and
generates the proposed IDSC solution comprising buildings name, latitude of the at least five buildings, and longitude of the at least five buildings, and an Area covered for the at least five buildings.

14. The apparatus as claimed in claim 6, determines the planned IDSC solution to:
determine whether any existing planned IDSC is available in a serving area of a site in the wireless network;
retrieve a roll out status of the at least three planned IDSC from a site master database when the three planned IDSC are available in a serving area of the site in the wireless network;
retrieve an EMS live status of the three planned IDSC from the site master database; and
generate the planned IDSC solution comprising a name of an existing building or pole, latitude of the at least three planned IDSC, longitude the three planned IDSC, the roll out status of the three planned IDSC, and the EMS live status of the three planned IDSC.

15. The apparatus as claimed in claim 1, wherein the apparatus comprises:
determining, by the apparatus, whether the at least one HUC is overshooting based on the sector class of the at least one HUC;
determining, by the apparatus, that the at least one HUC is mis-aligned when a sector angel meets a sector angel threshold; and
generating, by the apparatus, a cell coverage information comprising overshooting information of the at least one HUC and mis-alignment angle of the at least one HUC in the HUC decongestion report.

16. A method for mitigation of a highly utilized cell (HUC) in a wireless network comprising a plurality of cells, wherein the method comprises:
receiving, by an apparatus, a plurality of parameters associated with each cell from the plurality of cells;
determining, by the apparatus, at least one HUC from the plurality of cells based on the plurality of parameters associated with each cell from the plurality of cells;
detecting, by the apparatus, a sector class of the at least one HUC;
determining, by the apparatus, a mitigation plan based on the sector class of the at least one HUC; and
generating, by the apparatus, a HUC decongestion report for mitigation of the at least one HUC in the wireless network, wherein the HUC decongestion report comprises information about the at least one wireless network, information about the at least one HUC, the sector class of the at last one HUC, and the mitigation plan.

17. The method as claimed in claim 16, wherein determining, by the apparatus, the at least one HUC from the plurality of cells based on the plurality of parameters associated with each cell from the plurality of cells comprises:
for each cell from the plurality of cells, determining by the apparatus whether the plurality of parameters meets a HUC criteria;
detecting, by the apparatus, at least one candidate cell from the plurality of cells whose parameters meets the HUC criteria;
determining, by the apparatus, whether the at least one candidate cell consistently meets the HUC criteria for a period of time; and
identifying, by the apparatus, the at least one candidate cell as the at least one HUC when the at least one candidate cell consistently meets the HUC criteria for the period of time.

18. The method as claimed in claim 16, wherein detecting, by the apparatus, the sector class of the at least one HUC comprises:
detecting, by the apparatus, a number of HUC per sector per site in the wireless network; and
detecting, by the apparatus, the sector class of the at least one HUC based on the number of HUC per sector per site in the wireless network.

19. The method as claimed in claim 16, wherein the mitigation plan comprises a proposed additional layer solution, a proposed bi-sector antenna solution, a proposed Outdoor Small Cells (ODSC) solution, a planned ODSC solution, a proposed Indoor Small Cell (IDSC) solution, a planned IDSC solution, a new macro site solution, and a planned macro site solution.

20. The method as claimed in claim 16, wherein the method comprises:
determining, by the apparatus, whether the at least one HUC is overshooting based on the sector class of the at least one HUC;
determining, by the apparatus, that the at least one HUC is mis-aligned when a sector angel meets a sector angel threshold; and
generating, by the apparatus, a cell coverage information comprising overshooting information of the at least one HUC and mis-alignment angle of the at least one HUC in the HUC decongestion report.
